(19) United States
(12) Patent Application Publication
(10) Pub. No.: US 2012/0090100 A1
(43) Pub. Date: Apr. 19, 2012

(54) COMPOSITION

(75) Inventors: Laura Roscioli, VE Mira (IT); Umberto Toniolo, VE Mira (IT)

(73) Assignee: Reckitt Benckiser N.V., Hoofddorp (NL)

(21) Appl. No.: 13/259,428

(22) PCT Filed: Mar. 18, 2010
(86) PCT No.: PCT/GB10/00508

§ 371 Date: Dec. 22, 2011

(30) Foreign Application Priority Data
Mar. 25, 2009 (GB) 0905109.5
Jul. 16, 2009 (GB) 0912328.2

(51) Int. Cl. D06L 1/16; C11D 3/60

(52) U.S. Cl. 8/137; 510/284

(57) ABSTRACT

An aqueous composition comprises a bleach and a cationic surfactant for use as a pre-treatment composition in a laundry/fabric washing operation.

The present invention relates to an aqueous cleaning composition comprising a cationic surfactant and a bleach.

Cleaning compositions are well known and find use in household environments for cleaning various objects including hard surfaces and laundry.

Aside from achieving the cleaning operation itself, i.e. the removal of dirt from the object being cleaned, there is a desire for the cleaning compositions to have an anti-microbial effect. The benefits of such an effect are self-explanatory: any reduction or elimination of microbial species on a surface is seen to beneficial in the prevention/reduction of infections in the users of said items. The reduction of the microbial population is also connected with a reduction on malodour on a surface.

In some laundry applications certain phenol based compounds have been used to address this aim. Whilst the results attained using these compounds (in terms of microbial elimination) have been seen to be beneficial there is some doubt as to the environmental acceptability and toxicity of these compounds.

Thus there is a need for a new anti-microbial composition suitable for a cleaning (particularly a laundry/clothes application).

According to the present invention there is provided an aqueous composition comprising a bleach and a cationic surfactant for use as a pre-treatment composition in a laundry/fabric washing operation.

Surprisingly, it has been found that the composition and use of the present invention have improved performance in stain treatment when used in a fabric/laundry cleaning operation. It is postulated that the bleach and the cationic surfactant operate synergistically to give an excellent effect in microbial treatment (particularly bacteria and fungi). Additionally superior stain treatment has been observed.

Furthermore we have unexpectedly discovered that in use in laundry washing operations (with the cationic surfactant) the composition aids the reduction of colour damage on fabrics. Without being bound to theory we believe that the positive charge interacts with the fabric (e.g. cotton) surface to improve the shielding of the dye from fading.

Preferably the composition comprises from 0.001% to 99.99%, preferably 0.05% to 20%, preferably 0.05% to 5%, most preferably about 1.70%, by weight, of cationic surfactant. The cationic surfactant is preferably of the formula below:

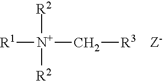

in which:

Z^{˜}is an anionic counter-ion,

R¹ is a straight or branched C6 to C20 alkyl or alkenyl group,

Any suitable counter-ion may be used in the cationic surfactant. Preferred counter-ions for the cationic surfactants include halogens (especially chlorides), methosulphate, ethosulphate, tosylate, phosphate and nitrate. Chlorides are preferred. It is preferable that no further cationic surfactants are present other than the up to 30% forming the mixed cationic system.

In the formulae given above it is preferred that the longer chain R¹ is an unbranched, linear chain. The preferred chain length of R¹ is C8-C20, more preferably C12-C18 and the carbon- carbon bonds are preferably saturated. The shorter chain R² is preferably methyl or ethyl. The aromatic group R³ is preferably phenyl (such that the quaternary nitrogen is effectively substituted with a benzyl group). R⁴ is preferably methyl, ethyl or hydroxyl-ethyl. Where present, A is preferably ethoxy (—CH₂—CH₂—O—). Where, for example a substituent appears more than once in a formula the two or more groups substituted need not be the same.

A preferred surfactant has R¹ as fatty (preferably C12-C18) alkyl. This is believed to give optimal biocidal properties. Preferably, R² is methyl and R³ is phenyl. A particularly preferred surfactant is benzalkoium chloride (which is a fatty (C10-C18) alkyl dimethyl benzyl ammonium chloride). Various grades of this material are available, and ones rich in the C12-C16 fatty residues are preferred.

Preferably the composition comprises from 0.001% to 99.99%, preferably 0.001% to 20%, preferably 4% to 18%, e.g. most preferably about 4.5% or 13%, by weight, of bleach. The bleach is preferably peroxide bleach, most preferably hydrogen peroxide. Peroxide sources other than H₂O₂ can be used.

Preferably the fabric treatment composition comprises a second surfactant. Where present the composition comprises from 0.001% to 99.99%, preferably 0.05% to 15%, e.g. about 7%, by weight of surfactant.

The surfactant is, for example, an anionic or nonionic surfactant or mixture thereof (most preferably a nonionic surfactant). The nonionic surfactant is preferably a surfactant having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol trade name from Shell Co.), such as C₁₁ alkanol condensed with 9 moles of ethylene oxide (Neodol 1-9), C₁₂-₁₃ alkanol condensed with 6.5 moles ethylene oxide (Neodol 23-6.5), C₁₂₋₁₃ alkanol with 9 moles of ethylene oxide (Neodol 23-9), C12-15 alkanol condensed with 7 or 3 moles ethylene oxide (Neodol 25-7 or Neodol 25-3), C₁₄₋₁₅ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol trade name such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other examples of linear primary alcohol ethoxylates are available under the Lutensol trade name such as, for example, Lutensol A3N, a C₁₃₋₁₅ linear primary alcohol ethoxylate with 3 moles EO; Lutensol LA60, a C₁₃₋₁₅ linear primary alcohol ethoxylate with 7 moles EO. Also Genapol such as, for example, Genapol LA3, a C₁₃₋₁₅ linear primary alcohol ethoxylate with 3 moles EO; Genapol LA070, a C₁₃₋₁₅ linear primary alcohol ethoxylate with 7 moles EO

Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds. comprise a carbon chain containing 12 to 20 carbon atoms.

Other surfactants which may be used are alkyl naphthalene sulfonates and acyl/oleoyl sarcosinates and mixtures thereof.

The fabric treatment composition may various optional ingredients, including enzymes, builders, solvents, dye transfer inhibition agents, dye catchers, preservatives, anti-oxidants, anti-static agents, fragrances, odour absorbing components, optical brighteners, acidifying agents, alkalizing agents, thickeners (e.g. hydroxyethylcellulose and/or xanthan gum).

The pH range of the fabric treatment composition is typically from about 1 to about 8, e.g. from 3 to 5, more preferably from 3.6-4.3.

A most preferred composition is below:

Non Ionic Surfactant: 0.05% to 15%

Cationic Surfactant: 0.05% to 5%

H₂O₂ 50%: 4% to 18%

Fragrance: 0.1-0.5 wt%

Dye: 0.1-1.0 wt%

Water: Rest

The composition is preferably used in a washing machine cycle and/or as a pre-soaker/soaker in a clothes cleaning operation.

1. A fabric pre-treatment composition adapted for use in a laundry or fabric washing operation. said composition comprising; water, a bleach and a cationic surfactant.

2. A composition according to claim 1, wherein the bleach is present in an amount of 4% wt, to 18% wt.

3. A composition according to claim 2, wherein the bleach comprises hydrogen peroxide.

4. A composition according to claim 1, wherein the cationic surfactant is present in an amount of 0.05% wt. to 5% wt.

5. A composition according to claim 4, wherein the cationic surfactant comprises a surfactant of the formula below. 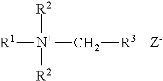
wherein:
R1 is a straight chained or branched C6 to C20 alkyl or alkenyl group;
R2 is methyl or ethyl;
R3 is an aromatic group;
R4 is selected from methyl ethyl, and hydroxyl-ethyl,
and
Z is a counterion

6. A composition according to claim 5, wherein the cationic surfactant comprises alkyl dimethyl benzyl ammonium chloride.

7. A method of pretreating a fabric in a laundry operation or fabric washing operation, the method comprising the steps of:
contacting a fabric with a fabric pre-treatment composition according to claim 1 to provide a pre-treatment effect to the fabric
subsequently, subjecting the pre-treated fabric to a laundry operation or fabric washing operation.

8. The method according to claim 7, wherein the fabric is a cotton fabric.

9. A method reducing colour damage imparted to a coloured fabric, the method comprising the steps of:
contacting the fabric with a fabric pre-treatment composition according to claim 1 to provide a pre-treatment effect to the fabric
subsequently, subjecting the pre-treated fabric to a laundry operation or fabric washing operation.

10. The method according to claim 9, wherein the fabric is a cotton fabric.
